(19) United States
(12) Patent Application Publication
(10) Pub. No.: US 2007/0246502 A1
(43) Pub. Date: Oct. 25, 2007

(54) EJECTOR TAB STRUCTURE FOR A NAILER

(75) Inventors: Chien-An Liu, Taichung City (CN); Chun-Chi Lai, Taichung City (CN)

Correspondence Address: EGBERT LAW OFFICES, 412 MAIN STREET, 7TH FLOOR, HOUSTON, TX, 77002, US

(73) Assignee: BASSO INDUSTRY CORP., Taichung City (TW)

(21) Appl. No.: 11/695,567

(22) Filed: Apr. 2, 2007

(30) Foreign Application Priority Data
Apr. 24, 2006 (TW) 095114561

(51) Int. Cl. B25C 5/06

(52) U.S. Cl. 227/120

(57) ABSTRACT

The present invention provides an ejector tab structure for a nailer cartridge, which is mounted at a preset location of the nailer cartridge. The ejector tab is provided with an ejector to push the collated nails. The present invention includes a first and second ejector, the first ejector aligning with the first groove of a guide groove, the second ejector aligning with the second groove of the guide groove. The first and second grooves are separated through a rejector of the nailer cartridge. The first ejector aligns with the lower part of the long collated nails, and the second ejector aligns with the upper part. When either long or short collated nails are assembled into the nailer cartridge, a more reliable ejection state is achieved to ensure accurate nailing, improving the performance and extending the service life of the nailer.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a nailer structure, and more particularly to an innovative ejector tab structure for a nailer cartridge of a nailer.

2. Description of Related Art Including Information Disclosed Under 37 CFR 1.97 and 37 CFR 1.98.

The nailer cartridge of a nailer is used to accommodate and guide collated nails into the nailer.

The nailer cartridge is generally equipped with an ejector tab, having an ejector at the front of the ejector tab to flexibly push the collated nails towards the outlet of the nailer. The ejector of a typical ejector tab is provided with a flat surface or oblique plane of a preset length, serving the purpose of pushing the collated nails.

This ejector tab structure has disadvantages in application. For example, given the variety of long and short collated nails for a nailer, the ejector of the ejector tab is often restricted to the lower part of the corresponding collated nails. In such a case, a stable pushing is achieved when short collated nails are used. However, there is unstable pushing when long collated nails are used. The upper parts of the long collated nails are not pushed by the ejector, so that distortion occurs due to uneven stress on upper and lower parts of the long collated nails. Thus, a slight distortion likely impedes the nailing and also affects the performance and service life of nailers.

Another disadvantage is that the linear surface of the ejector greatly increases the area and weight of ejector tab, if the ejector is extended upwards to match the maximum length of collated nails for stable pushing long collated nails. Moreover, in the case of collated nails with expanded nail heads, these collated nails cannot be positioned stably, leading to angular deviations.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The enhanced efficacy of the present invention addresses the prior art problem of having an ejector provided with a flat surface or oblique plane of a preset length. In the case of long collated nails, the pushing force is concentrated on lower part, such that the upper part of the long collated nails is not pushed. Thus, angular deviation occurs due to uneven stress on upper and lower parts of the long collated nails.

In the present invention, the ejector of ejector tab 10 is formed into bifurcated or manifold patterns to form the first ejector 12 and at least a second ejector 13. The short collated nails A1 are pushed independently by the first ejector 12. The nail head 52 of the collated nails A1 aligns with the concave space (W) formed by the first and second ejectors 12, 13, serving the purpose of collision and stable engagement of nail bodies. The long collated nails A2 are jointly pushed by the first ejector 12 and second ejector 13, since a two point uniform thrust of upper and lower parts of long collated nails A2 ensures an accurate ejecting angle of the long collated nails, thus providing more stable ejecting behavior and longer service life.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the preferred embodiment of the present invention.

FIG. 2 shows an assembled perspective view of the preferred embodiment of the present invention.

FIG. 3 shows a partial isolated elevation view of the ejector tab of the present invention in a rested state.

FIG. 4 shows another partial isolated elevation view of the ejector tab of the present invention in a pressed state.

FIG. 5 shows a schematic view of ejector patterns of the ejector tab of the present invention.

FIG. 6 shows a schematic view of the present invention for short collated nails.

FIG. 7 shows another schematic view of the present invention for long collated nails.

FIG. 8 shows a partial isolated perspective view of a guide groove for a nailer cartridge of the present invention.

FIG. 9 shows another partial isolated perspective view of another guide groove for a nailer cartridge of the present invention.

FIG. 10 shows a schematic view of the ejector tab of the guide groove for a nailer cartridge of the present invention as shown in FIG. 9 for long collated nails.

FIG. 11 shows another schematic view of the ejector tab of the guide groove for a nailer cartridge of the present invention as shown in FIG. 9 for short collated nails.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

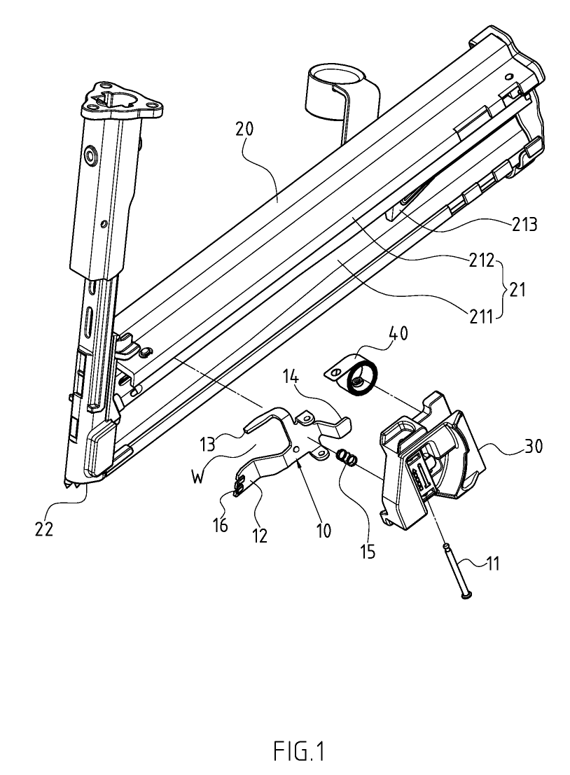

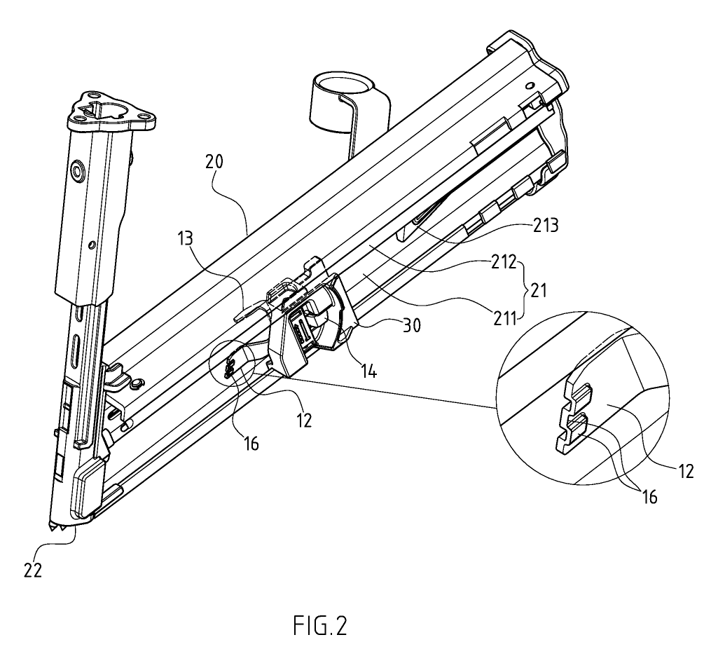

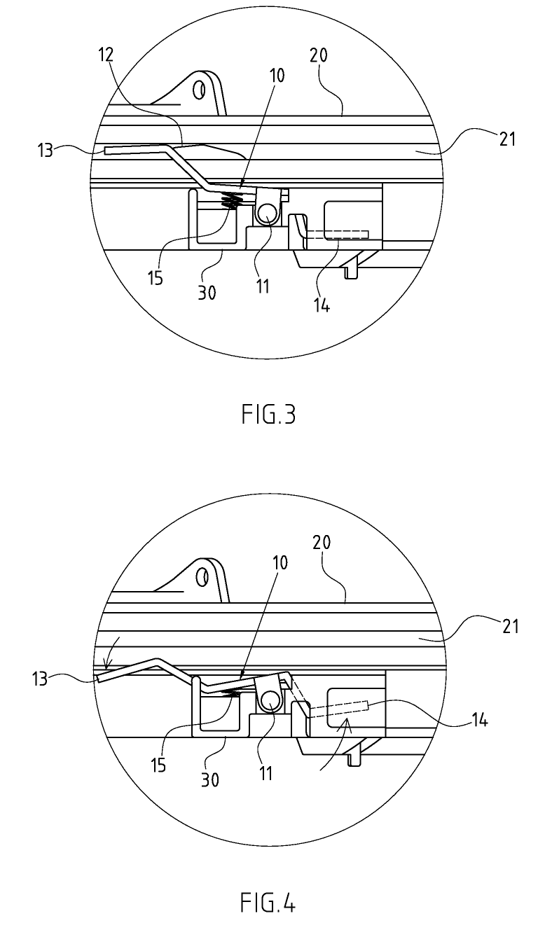

FIGS. 1, 2 and 3 depict preferred embodiments of the ejector tab for a nailer cartridge of the present invention. The ejector tab 10 is placed at a preset location of nailer cartridge 20, which is internally provided with a guide groove 21 to accommodate the collated nails. The guide groove 21 comprises the first groove 211 and second groove 212, which are separated by a rejector 213 of nailer cartridge 20. One end of nailer cartridge 20 is linked to outlet 22 of the nailer. The ejector tab 10 of the preferred embodiment is screwed onto the slider 30 via a shaft bolt 11, such that the ejector tab 10 slides along the preset guide groove of the nailer cartridge 20 along with the slider 30. With a flexible resetter 40 (a scroll spring in the preferred embodiment), the ejector tab 10 and slider 30 are assembled in a manner to ensure flexible resetting towards the outlet 22.

An ejector is mounted at a front of ejector tab 10 to push the collated nails towards the outlet 22. The bifurcated ejector of the preferred embodiment comprises a first ejector 12 and at least a second ejector 13, between which there is a concave space (W). The first ejector 12 aligns with the first groove 211 of guide groove 21, and the second ejector 13 aligns with the second groove 212 of guide groove 21. On the other hand, the far end of ejector tab 10 protrudes from the slider 30 to form a rejector 14. So, the operator presses the rejector 14 to make the first and second ejectors 12, 13 of ejector tab 10 swing outwards (shown in FIG. 4), such that the guide groove 21 of nailer cartridge 20 provides a space for insertion of collated nails or troubleshooting. A flexible member 15 (a spring in the preferred embodiment) is mounted between the rejector 14 and slider 30 for resetting of the rejector 14.

The first ejector 12 and second ejector 13 could be pre-formed by the ejector tab 10, such as punching of metal plates.

A rough flange 16 is set at the end of first ejector 12 in order to increase the contact area of the ejector 12 for more stable ejection. The rough flange 16 can also be applied onto the second ejector 13.

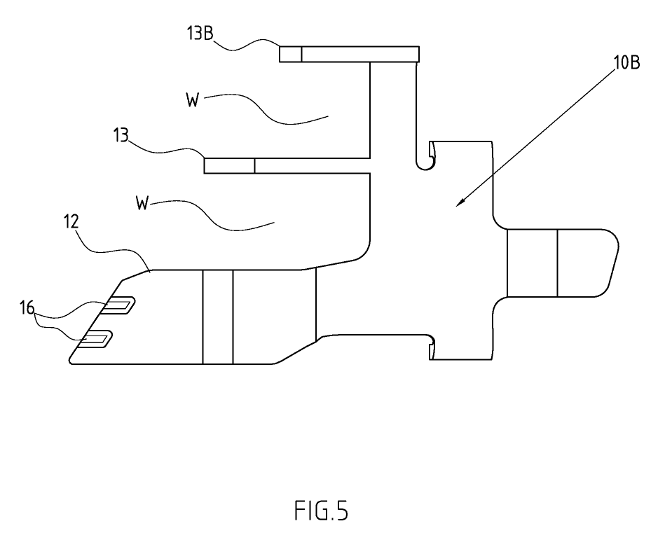

The second ejector 13 of ejector tab 10 may also be available in other models. Referring to FIG. 5, the ejector tab 10B is fitted with second ejectors 13 and 13B. With addition of second ejector 13B, the requirement of longer collated nails can be satisfied.

The key part of the ejector tab structure for a nailer cartridge is that the ejector of ejector tab 10 has bifurcated or manifold patterns to form the first ejector 12 and at least a second ejector 13, which differs a lot from the ejector with a single or oblique plane.

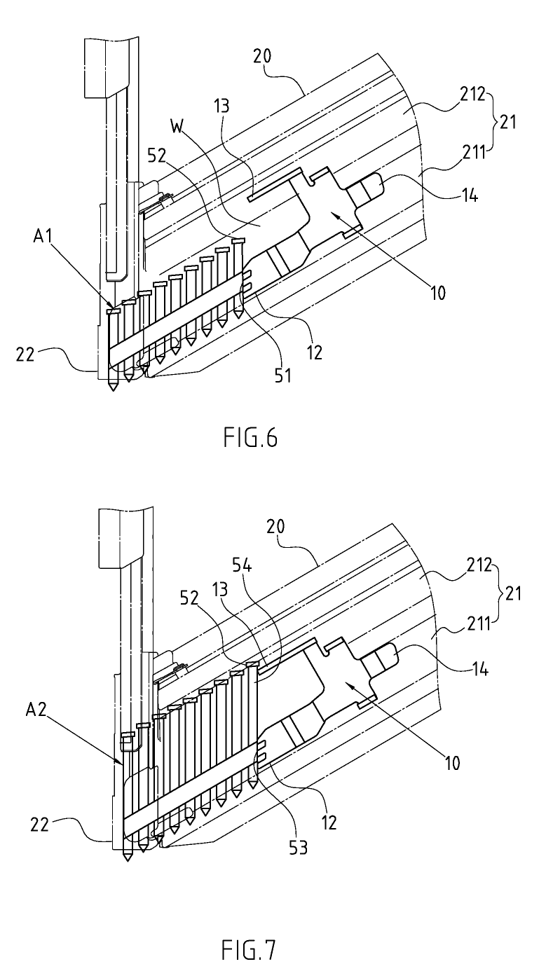

Referring to FIG. 6, when shorter collated nails A1 are inserted into the nailer cartridge 20, the first ejector 12 of ejector tab 10 pushes the collated nails A1. Since the height of first ejector 12 almost corresponds to the short collated nails A1, the first ejector 12 pushes right at the middle section 51 of the short collated nails. The expanded nail head 52 of collated nails aligns with the concave space (W), such that the nail body is stably engaged by the first ejector 12 to ensure the desired ejecting angle of collated nails A1 and extremely stable ejection.

Referring also to FIG. 7, when longer collated nails A2 are inserted into the nailer cartridge 20, two point contact of first ejector 12 and second ejector 13 enables ejecting of the collated nails A2. The lower part 53 of the longer collated nails A2 are pushed by the first ejector 12, and the upper part 54 of collated nails A2 are pushed by the second ejector 13. In such a case, the nail heads 52 of collated nails A2 align with the upper position of the second ejector 13 making it possible to avoid collision. So, the two point uniform thrust of upper and lower parts on the long collated nails A2 ensure an accurate ejecting angle of long collated nails for more stable ejecting behavior.

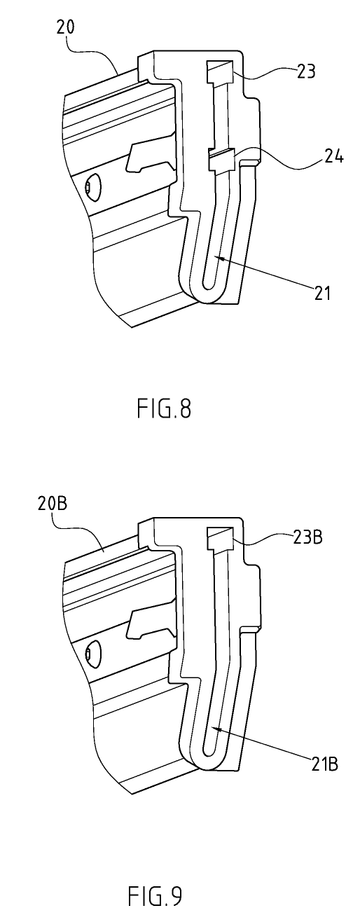

FIG. 8 shows a perspective view of the inlet of guide groove 21 for nailer cartridge 20 of the present invention. When the nailer cartridge 20 accommodates the collated nails with the nail tail as a benchmark, expanded nail head grooves 23, 24 are arranged at intervals on the guide groove 21. Yet, the ejector tab 10 with bifurcated or manifold ejectors is not limited to the guide groove pattern of nailer cartridge 20. For another nailer cartridge 20B as shown in FIG. 9, a nail head groove 23B is arranged at a top of the guide groove 21B. The nail head serves as the benchmark when such a nailer cartridge 20B accommodates the collated nails. The ejector tab 10 of the present invention could also suitable for this nailer cartridge. When either long or short collated nails are inserted into nail head groove 23B, the first ejector 12 and second ejector 13 of the ejector tab 10 will stop close to the nail head. But, the concave space (W) formed by the first ejector 12 and second ejector 13 cannot avoid collision with the nail heads.

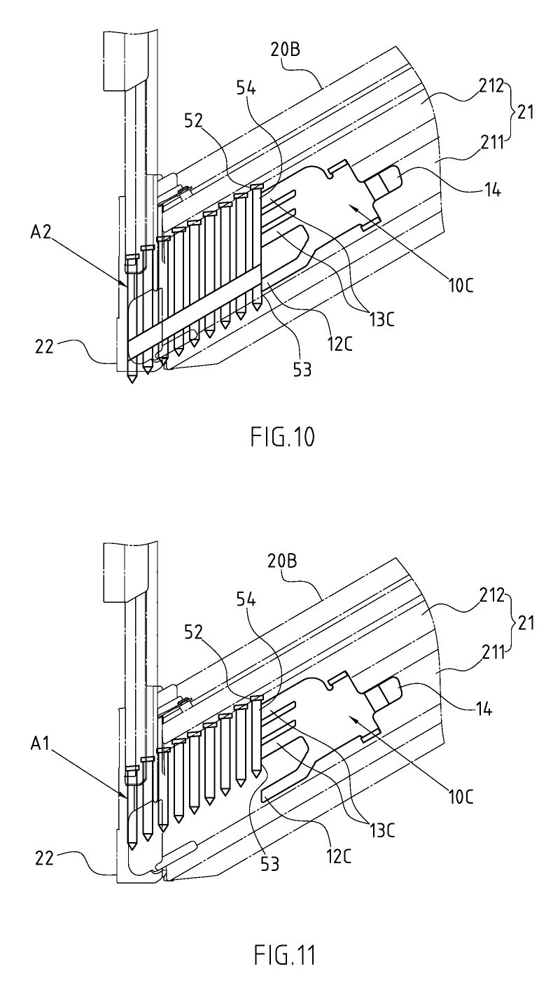

Referring to FIG. 10, when long collated nails A2 are inserted into the guide groove 21 of nailer cartridge 20B, the second ejector 13C of ejector tab 10C pushes the upper part 54 of long collated nails A2, and the first ejector 12C pushes the lower part 53 of long collated nails A2. Referring also to FIG. 11, when short collated nails A1 are inserted into the guide groove 21 of nailer cartridge 20B, the second ejector 13C of ejector tab 10C pushes the upper part 54 of short collated nails A1, but the first ejector 12C does not stop at the short collated nails A1. In such case, the short collated nails A1 are pushed by the second ejector 13C.

I claim:

1. An ejector tab structure for a nailer cartridge, said nailer cartridge having a preset guide groove and containing a plurality of collated nails, said guide groove comprising a first groove and a second groove, said nailer cartridge having a rejector separating said first groove and said second groove, said ejector tab structure comprising:
an ejector engaging said collated nails for pushing said collated nails out of said nailer cartridge, said ejector being comprised of a first ejector and a second ejector, said first ejector being aligned with said first groove, said second ejector being aligned with said second groove, said ejector being placed at a preset location of said nailer cartridge and being slideable along said guide groove of said nailer cartridge.

2. The ejector tab structure defined in claim 1, wherein said first ejector and said second ejector are pre-formed by said ejector tab.

3. The ejector tab structure defined in claim 1, wherein said first ejector is formed in a bifurcated pattern.

4. The ejector tab structure defined in claim 1, wherein said first ejector is formed in a manifold pattern.

5. The ejector tab structure defined in claim 1, wherein said second ejector is formed in a manifold pattern.

6. The ejector tab structure defined in claim 1, wherein said first ejector and said second ejector have a concave space defined therebetween.

7. The ejector tab structure defined in claim 1, wherein said first ejector has a rough flange set at an end thereof.

8. The ejector tab structure defined in claim 1, wherein said second ejector has a rough flange set at an end thereof.

9. The ejector tab structure defined in claim 1, wherein said nailer cartridge has a slider engaging said ejector via a pivot connection to a shaft bolt achieving a swinging behavior, said ejector having an end protruding from said slider to form a rejector, said ejector and said slider having a flexible member mounted therebetween, resetting of said rejector.

10. The ejector tab structure defined in claim 1, wherein said collated nails have an upper part and a lower part, said first ejector pushing said lower part of said collated nails, said second ejector pushing said upper part of said collated nails, said collated nails engaging said first groove at a bottom of said first groove.

11. The ejector tab structure defined in claim 1, wherein said collated nails have an upper part and a lower part, said first ejector pushing said lower part of said collated nails, said collated nails engaging said first groove at a bottom of said first groove.

12. The ejector tab structure defined in claim 1, wherein said collated nails have an upper part and a lower part, said first ejector pushing said lower part of said collated nails, said second ejector pushing said upper part of said collated nails, said collated nails engaging said second groove at a top of said second groove.

13. The ejector tab structure defined in claim 1, wherein said collated nails have an upper part and a lower part, said second ejector pushing said upper part of said collated nails, said collated nails engaging said second groove at a top of said second groove.
